(19) United States
(12) Patent Application Publication
(10) Pub. No.: US 2008/0083663 A1
(43) Pub. Date: Apr. 10, 2008

(54) ADJUSTABLE FINGER SCREEN

(75) Inventor: Ronald J. Zorn, Crystal Lake, IL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: GENERAL KINEMATICS CORPORATION, Crystal Lake, IL (US)

(21) Appl. No.: 11/861,943

(22) Filed: Sep. 26, 2007

Related U.S. Application Data
(60) Provisional application No. 60/827,032, filed on Sep. 26, 2006.

(51) Int. Cl. B07B 1/12; B07B 1/46

(52) U.S. Cl. 209/674; 209/393; 209/394

(57) ABSTRACT

A finger screen includes a plurality of first fingers, the plurality of first fingers defining a plurality of first spaces between adjacent first fingers, and a plurality of second fingers. In a first state, the plurality of second fingers is attached to the plurality of first fingers such the second fingers occlude a first percentage of the first spaces. In a second state, the plurality of second fingers is attached to the plurality of first fingers such that the second fingers occlude a second percentage of the first spaces, the first and second percentages being different.

This application claims the benefit of U.S. Application No. 60/827,032, filed Sep. 26, 2006, which is hereby incorporated by reference in its entirety in the present application

### BACKGROUND

This patent is directed to apparatuses and methods for screening materials, and, in particular, to apparatuses and methods for using finger screens to screen materials.

Finger screens have been in use for some time in material separators, such as those that may be driven by a vibration generator. U.S. Pat. No. 5,108,589 discloses one such finger screen, and one such separator. As described therein, the finger screen is comprised of finger screen sections. Each finger screen section has a backbone extending between sides, which sides may be secured to the sides of a trough. Forwardly extending fingers are connected at one end to the backbone. The fingers define spaces between adjacent fingers, and are spaced from each other, fore and aft, to define further spaces. These spaces permit particles up to a preselected size pass through the screen section and into the trough.

Conventionally, a variety of finger screens, each with particularly-sized openings and spacings, are manufactured to accommodate a variety of particle sizes. That is, individual finger screens are manufactured with particularly-sized openings between adjacent fingers and a particular spacing, fore and aft, between overlapping fingers. A particular finger screen is then selected for a particular application by comparing the size of the openings and the spacing of the screen to the expected sizes of the particles to be removed from a material.

It may be difficult, however, to accurately estimate the size of the finger screen required for a particular application. For example, it may not be known initially what range of particle sizes are present in a material, such that an appropriate particle size for screening (and, hence, appropriate finger screen) may be a matter of educated guesswork. Even if testing is performed on a sample of the material to be screened prior to selection of a finger screen, it may turn out that the testing sample is not representative of operational material streams (or batches), perhaps because of cyclic variations in the composition of the operational streams. For example, the material to be screened may exhibit seasonal variation in the particle sizes of the materials in the stream (or batch). As another alternative, the user may change the desired parameters of the screening to be performed over time (i.e., it may be desired to remove a first particle size or smaller at one time, and then, at another time, it may be desired to remove a second particle size or smaller, the first and second particle sizes being different from each other).

When the screen is not accurately selected, for whatever the underlying reason, complications can arise. While finger screens may be designed to be removed in sections, such that the substitution of one finger screen for another may not require disassembly or substitution of the entire trough, this does not mean that it is a simple matter to remove and replace finger screens when it is determined that a smaller or larger spacing is required. The screens may be made of steel and the like, and may be several yards long, as well as yards wide. Manipulating one set of screens out of place, and another into place, is a significant investment of time and manpower. Furthermore, the machine cannot be operated while the replacement process is taking place.

Consequently, it is desired to have alternative apparatuses and methods for screening materials using a finger screen where the size of the particles to be screened cannot accurately be estimated prior to installation of the finger screen, or where it may be subject to variation or change.

### SUMMARY

According to an aspect, a finger screen includes a plurality of first fingers, the plurality of first fingers defining a plurality of first spaces between adjacent first fingers, and a plurality of second fingers. In a first state, the plurality of second fingers is attached to the plurality of first fingers such the second fingers occlude a first percentage of the first spaces. In a second state, the plurality of second fingers is attached to the plurality of first fingers such that the second fingers occlude a second percentage of the first spaces, the first and second percentages being different.

According to another aspect, a finger screen includes at least one backbone having a plurality of first fingers depending therefrom, each of the first fingers having side edges, and at least one adjustment plate having a plurality of second fingers depending therefrom, each of the second fingers having at least one side edge, the at least one side edge of the second finger and one of the side edges of an adjacent first finger defining an opening distance therebetween. In a first state, the at least one adjustment plate is attached to the at least one backbone such that the opening distance is a first value. In a second state, the at least one adjustment plate is attached to at least one backbone such that the opening distance is a second value, the first and second values being different.

### BRIEF DESCRIPTION OF THE DRAWINGS

FIG. 1 is a plan view of an finger screen according to the present disclosure;

FIG. 2 is a side view of a finger screen of FIG. 1, with the adjustable plates removed;

FIG. 3 is a fragmentary, enlarged side view of the finger screen of FIG. 1, with the adjustable plates included;

FIG. 4 is a fragmentary, enlarged plan view of the finger screen of FIG. 1; and

FIG. 5 is a schematic view of a vibratory apparatus including a finger screen according to the present disclosure.

### DETAILED DESCRIPTION OF VARIOUS EMBODIMENTS

Although the following text sets forth a detailed description of different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

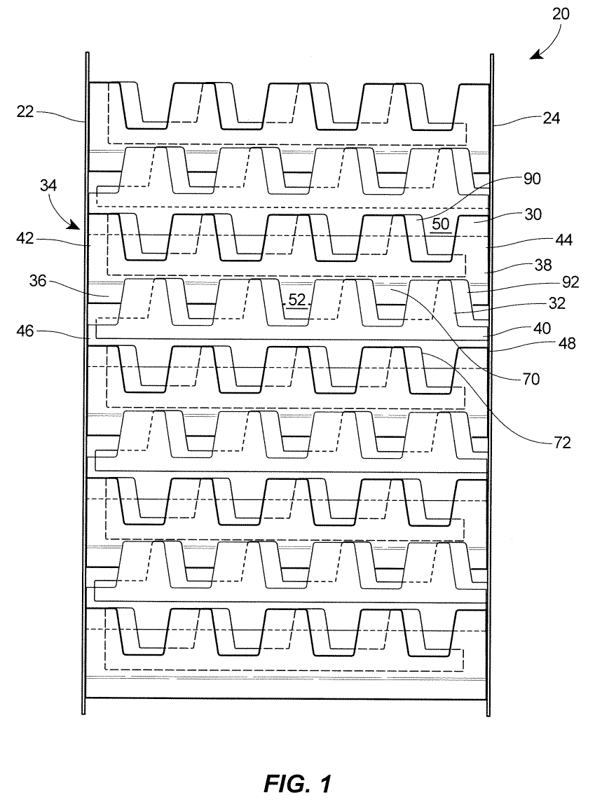

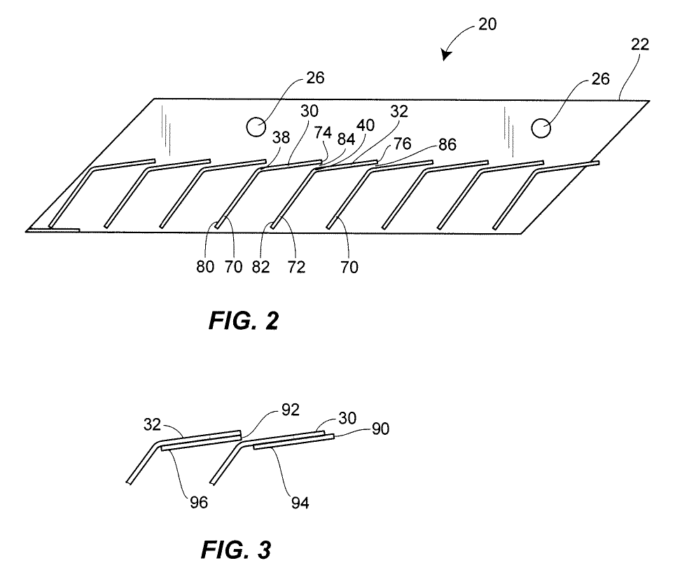

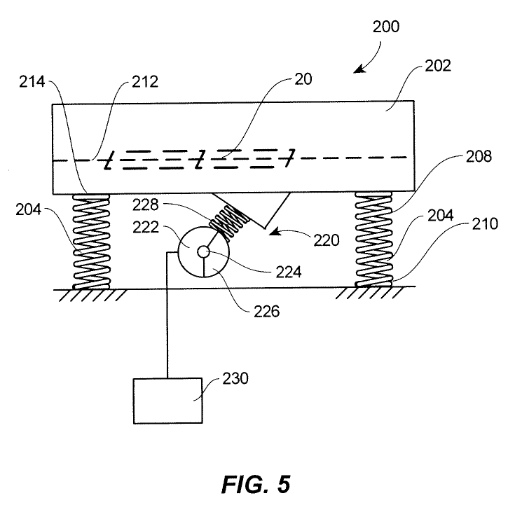

Referring first to FIGS. 1 and 2, a finger screen 20 is shown. The finger screen 20 may be used in a separator, such as may be driven by a vibration conveyor, as is illustrated in U.S. Pat. No. 5,108,589, which is hereby incorporated in its entirety herein. Further alternative vibratory apparatuses are illustrated in FIG. 5. The screen 20 may include side plates 22, 24. The side plates 22, 24 may be secured to the sides of a trough, for example through the use of fasteners disposed in holes 26 (see FIG. 2) formed in the side plates 22, 24.

Between the side plates 22, 24 may be disposed pluralities of fingers 30, 32 arranged in a plurality of rows 34, 36. In particular, each row 34, 36 may have a backbone 38, 40 to which the pluralities of fingers 30, 32 may be attached and from which the pluralities of fingers 30, 32 may depend. As illustrated, the pluralities of fingers 30, 32 may be integral with the backbones 38, 40. The backbones 38, 40 may be attached at ends 42, 44, 46, 48 to the side plates 22, 24, by welding, for example.

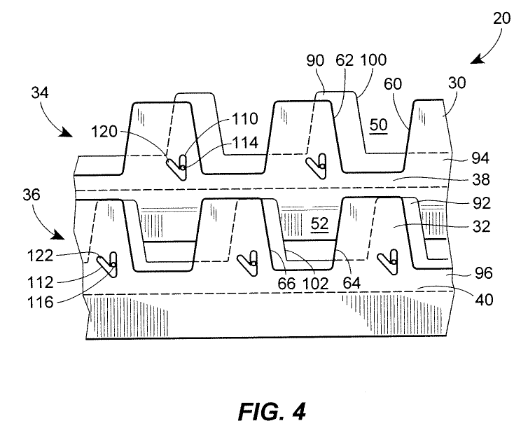

The fingers 30, 32 may define a plurality of spaces 50, 52 between adjacent fingers 30, 32. That is, as best seen in FIG. 4, adjacent fingers 30, 32 may have facing side edges 60, 62, 64, 66 which define the spaces 50, 52 on either side. The spaces 50, 52 may also be bounded at one end by the backbones 38, 40, with the opposite end remaining open.

The fingers 30, 32 in each of the rows 34, 36 may be offset, such that the fingers 30 of row 34 may not be aligned with the fingers 32 of row 36. This is illustrated in FIGS. 1 and 4. As a consequence, the spaces 50, 52 defined by the respective rows 34, 36 of fingers 30, 32 may also be offset.

A leg 70, 72 may also be attached at one end to the backbone 38, 40 and depend therefrom. In particular, the legs 70, 72 may depend from the backbones 38, 40 in the opposite direction from the fingers 30, 32. The leg 70, 72 may be of sufficient length as to depend for some distance beneath the forwardmost portion 74, 76 of adjacent fingers 30, 32 (see FIG. 2). In fact, the rows 34, 36 of fingers 30, 32 may be spaced such that the distance between the surfaces 80, 82 of the legs 70, 72 and the forwardmost portion 74, 76 of the fingers 30, 32 define further plurality of spaces 84, 86.

Associated with each of the pluralities of fingers 30, 32 may be another plurality of fingers 90, 92. The pluralities 90, 92 of fingers may be attached to and depend from a plate 94, 96, similar to the backbones 38, 40. However, as illustrated, there are no legs depending from the plates 94, 96 in addition to the fingers 90, 92.

According to the illustrated embodiment, and as best seen with reference to FIG. 3, the plates 94, 96 are disposed beneath the fingers 30, 32. This arrangement is not necessary or exclusive, and other arrangements of the plates 94, 96 may be encompassed by the present disclosure. However, it will be recognized that by disposing the plates 94, 96 beneath the fingers 30, 32 (and backbones 38, 40) any obstruction caused by the fingers 90, 92 and plates 94, 96 to the material passing over the screen 20 may be limited.

The fingers 90, 92 and associated plates 94, 96 may be moveable relative to the fingers 30, 32 and associated backbones 38, 40 and legs 70, 72. That is, in a first state, the fingers 90, 92 may be disposed relative to the fingers 30, 32 such that the fingers 90, 92 occlude a first percentage of the spaces 50, 52 defined between adjacent fingers 30, 32. In a second state, the fingers 90, 92 may be disposed relative to the fingers 30, 32 such that the fingers 90, 92 occlude a second percentage of the spaces 50, 52, the second percentage of being different than the first percentage.

Stated differently, with reference to FIG. 4, it will be recognized that the fingers 90, 92 have at least one side edge 100, 102 that opposes one of the side edges 60, 64 of one of the adjacent fingers 30, 32. The respective side edges 100, 102 and 60, 64 define an opening distance therebetween. In the first state, the opening distance may be a first value, and in the second state, the opening distance may be a second value that is different than the first value.

In any event, the fact that the fingers 90, 92 and associated plates 94, 96 are moveable relative to the fingers 30, 32, backbones 38, 40, and legs 70, 72 may permit one to vary the size of the openings through which particles may pass without removing one screen 20 and substituting another. That is, should it be desired to permit particles of larger size to pass through the screen 20, the fingers 90, 92 and plates 94, 96 may be moved relative to the fingers 30, 32 such that less of the openings 50, 52 are occluded. This would correspond to a movement of the fingers 90, 92 and plates 94, 96 to the left, as viewed in either FIG. 1 or 4. Alternatively, should it be desired to reduce the size of particles permitted to pass through the screen 20, the fingers 90, 92 and plates 94, 96 may be moved relative to the fingers 30, 32 such that more of the openings 50, 52 are occluded. This would correspond to a movement of the fingers 90, 92 and plates 94, 96 to the right, as viewed in either FIG. 1 or 4.

In the embodiments of the adjustable finger screen 20 illustrated in FIGS. 1 and 4, some portion of the spaces 50, 52 are always occluded by the fingers 90, 92 and plates 94, 96. It will be recognized that this need not always be the case. According to other embodiments of the adjustable finger screen 20, the fingers 90, 92 may be disposed such that they are substantially aligned with the respective fingers 30, 32 in the one state (leftmost position, as illustrated), and then advanced from that state (to the right, as illustrated) to occlude a percentage of the spaces 50, 52 in other states.

Furthermore, while the discussion above addresses a first and a second state, the present disclosure is not limited to embodiments having only two states in which only two opening sizes are possible. Rather, while according to certain embodiments the various states achievable may differ from each other in discrete steps, it is also possible to have an adjustable screen with a continuum of potential states. Furthermore, the present disclosure is not limited one possibility or the other, and may embrace both discrete steps and a continuum of states in a single embodiment (i.e., discrete steps over some portion of a range, and a continuum over another portion of a range).

Also associated with the screen 20 is an attachment or fastener to limit the movement of the fingers 90, 92 relative to the fingers 30, 32 when the fingers 30, 32 and fingers 90, 92 have been disposed in a particular arrangement relative to each other. According to one embodiment, the fingers 90, 92 and plates 94, 96 may be tack welded to the fingers 30, 32 and backbones 38, 40. It will be recognized that such an embodiment would involve a certain amount of effort should it be desired to change the arrangement of the fingers 90, 92 relative to the fingers 30, 32.

Another embodiment of an attachment or fastener for limiting movement of the fingers 90, 92 relative to the fingers 30, 32 is illustrated in FIG. 4. According to this embodiment, the plates 94, 96 have slots 110, 112 defined or formed therein. Likewise, the backbones 38, 40 have openings 114, 116. A fastener, such as a nut and bolt combination, may then be used to releasably attach or secure the plates 94, 96 to the backbones 38, 40 by disposing the bolt through, for example, the opening 114 and the slot 110 and then by threading the nut onto the bolt.

As illustrated, the slots 110, 112 may have a V- or other shape that may assist in arranging the plates 94, 96, and hence the fingers 90, 92, relative to the backbones 38, 40, and hence the fingers 30, 32. As will be recognized, the V-shaped slot 110, 112 provides a first state, wherein finger 90, 92 is disposed with a side edge at a first distance from an opposing edge of the finger 30, 32, and a continuum of settings from the first state to a maximum, represented by the end 120, 122 of the slot 110, 112.

Alternatively, the plates 94, 96 may be attached to the backbones 38, 40 via the side plates 22, 24 to attach the fingers 90, 92 to the fingers 30, 32.

FIG. 5 illustrates an embodiment of a vibratory apparatus 200 that may be used with the finger screen 20 according to the present disclosure. This embodiment is intended to be a non-limiting example of the possible apparatuses that may be used with the finger screen 20. For example, it will be recognized that considerable variation may occur relative to the structures that support the trough and in the manner and shape of the vibration generator, for example.

With reference first to FIG. 5, the apparatus 200 may include a trough 202 that is supported above a surface by a plurality of resilient members 204. According to certain embodiments, the resilient members 204 may be paired with linkages. The resilient members 204 may be attached at one end 208 to the trough 202 and at a second end 210 to the surface, typically via a support structure which may be bolted or otherwise secured to the surface. The trough 202 may have a deck 212 disposed therein, which deck 212 is defined in whole or in part by one or more finger screens 20. The trough 202 may include a floor 214 beneath the deck 212, as illustrated, or there may be an opening in the trough 202 beneath the deck 212. Further, the deck 212 may include other structures other than the finger screen 20.

One or more vibration generators 220 may be coupled to the trough 202. The vibration generator 220 may include a motor 222 having a shaft 224 to which one or more eccentric weights 226 are attached, for example. According to other embodiments, the vibration generator 220 may include pneumatic and/or hydraulic actuators instead of the motor 222. The motor 222 may be coupled to the trough 202 via one or more resilient members 228, as illustrated. It will be recognized that the motor 222 may instead be coupled directly to the trough 202, or to a counterbalance that is then attached to the trough 202. It will also be recognized that one or more weights or stabilizers may be used in conjunction with the motor 222.

The vibration generator 220 may cause motion of the trough 202 and associated deck 212, as well as motion of objects supported on the deck 212. The generator 220 may cause the objects to move from one end of the trough 202 to the other, may cause the objects to move up and down without significant lateral motion relative to either end, or some combination thereof. The operation of the generator 220 may be controlled by a controller 230 that may be coupled to the generator 220, particularly to the motor 222. The controller 230 may be programmable, and may vary the operation of the generator 220 such that objects move along the deck 212, move up and down relative to the deck 212, and then resume their motion along the deck 212.

I claim:

1. A finger screen comprising:
a plurality of first fingers, the plurality of first fingers defining a plurality of first spaces between adjacent first fingers; and
a plurality of second fingers,
in a first state, the plurality of second fingers being attached to the plurality of first fingers such the second fingers occlude a first percentage of the first spaces, and
in a second state, the plurality of second fingers being attached to the plurality of first fingers such that the second fingers occlude a second percentage of the first spaces, the first and second percentages being different.

2. The finger screen of claim 1, wherein, in a third state, the plurality of second fingers is attached to and aligned with the plurality of first fingers such that the second fingers occlude a third percentage of the first spaces, the third percentage being different than the first and second percentages and the third percentage being zero.

3. The finger screen of claim 1, further comprising at least one backbone attached to the plurality of first fingers and at least one adjustment plate attached to the plurality of second fingers, with an opening defined in the at least one backbone and a slot defined in the at least one adjustment plate, and a fastener being disposed through the opening and the slot to attach the at least one adjustment plate to the at least one backbone.

4. The finger screen of claim 3, wherein the slot provides a continuum of settings between the first state and the second state.

5. The finger screen of claim 4, wherein the slot is V-shaped.

6. A finger screen comprising:
at least one backbone having a plurality of first fingers depending therefrom, each of the first fingers having side edges;
at least one adjustment plate having a plurality of second fingers depending therefrom, each of the second fingers having at least one side edge, the at least one side edge of the second finger and one of the side edges of an adjacent first finger defining an opening distance therebetween,
in a first state, the at least one adjustment plate being attached to the at least one backbone such that the opening distance is a first value, and
in a second state, the at least one adjustment plate being attached to at least one backbone such that the opening distance is a second value, the first and second values being different.

7. The finger screen of claim 6, wherein the at least one adjustment plate is disposed beneath the at least one backbone.

8. The finger screen of claim 6, wherein the at least one adjustment plate and the plurality of second fingers are translatable relative to the at least one backbone and the plurality of first fingers.

9. The finger screen of claim 6, wherein the plurality of first fingers is integral with the at least one backbone.

10. The finger screen of claim 9, further comprising a space bounded by the side edges of adjacent first fingers and the at least one backbone, with the end opposite the at least one backbone remaining open.

11. The finger screen of claim 9, wherein the plurality of second fingers is integral with the at least one adjustment plate.

12. The finger screen of claim 6, wherein the plurality of second fingers is integral with the at least one adjustment plate.

13. The finger screen of claim 6, further comprising a leg that is attached to the at least one backbone, the first fingers depending in a first direction and the leg depending from the at least one backbone in a second direction opposite to the first direction such that an angle is formed between the leg and the first fingers.

14. The finger screen of claim 6, further comprising a side plate that is attached to the at least one backbone, the plurality of first fingers being in a first plane and the side plate being in a second plane orthogonal to the first plane.

15. The finger screen of claim 14, wherein the at least one backbone and the at least one adjustment plate are attached to the side plate.

16. The finger screen of claim 15, wherein at least one hole is defined in the side plate to receive a fastener to secure the side plate to a side of a trough.

17. The finger screen of claim 6, further comprising a fastener attaching the plurality of first fingers to the plurality of second fingers.

18. The finger screen of claim 17, further comprising a slot defined in the at least one adjustment plate and an opening in the at least one backbone, the fastener being disposed through the slot and the opening to attach the at least one adjustment plate to the at least one backbone.

19. The finger screen of claim 18, wherein the slot provides a continuum of settings between the first state and the second state.

20. The finger screen of claim 19, wherein the slot is V-shaped.
